(19) United States
(12) Patent Application Publication
(10) Pub. No.: US 2006/0250087 A1
(43) Pub. Date: Nov. 9, 2006

(54) Plasma display panel

(75) Inventor: Naoya Kikuchi, Nagoya-shi (JP)

Correspondence Address: OLIFF & BERRIDGE, PLC, P.O. BOX 19928, ALEXANDRIA, VA, 22320, US

(73) Assignee: NORITAKE CO., LIMITED, Nagoya-shi (JP)

(21) Appl. No.: 11/397,856

(22) Filed: Apr. 5, 2006

(30) Foreign Application Priority Data
Oct. 6, 2004 (JP) 2004-293492

(51) Int. Cl. H01J 17/49

(52) U.S. Cl. 313/582; 313/586; 313/587

(57) ABSTRACT

A plasma display panel including: (a) front and back plates cooperating to define a gas-tight space therebetween; (b) data electrodes each disposed on an inside surface of the back plate and elongated in a first direction; (c) ribs each disposed between a corresponding adjacent pair of the data electrodes and elongated in the first direction; and (d) sustain electrodes each covered with a dielectric layer, disposed between the front plate and the ribs, and elongated in a second direction intersecting the first direction. The plasma display panel is operable to produce an image which is formed of a visible light that is generated in a selected light emission section by cooperation of (i) a discharge generated between the data and sustain electrodes, and (ii) a sustain discharge generated between mutually opposed surfaces of the sustain electrodes. Each rib has a height that is smaller than a certain value of an electrode gap distance which minimizes a discharge initiating voltage in Paschen curve representative of a relationship between the discharge initiating voltage and a product of the electrode gap distance and a pressure in the gas-tight space.

This application is based on Japanese Patent Application No. 2004-293492 filed on Oct. 6, 2004, the content of which is incorporated hereinto by reference.

### BACKGROUND OF THE INVENTION

1. Field of the Invention

The present invention relates in general to a plasma display panel (PDP), and more particularly to an electrode arrangement in such a plasma display panel.

2. Discussion of Related Art

There is known a plasma display panel including (a) front and back plates disposed in parallel with each other and cooperating to define a gas-tight space therebetween, (b) a plurality of data electrodes each disposed on an inside surface of the back plate and elongated in a first direction, (c) a plurality of ribs each disposed between a corresponding adjacent pair of the data electrodes and elongated in the first direction; and (d) a plurality of sustain electrodes each covered with a dielectric layer, disposed between the front plate and the plurality of ribs, and elongated in a second direction intersecting the first direction, wherein the plasma display panel operable to produce an image which can be seen through the front plate and which is formed of a visible light that is generated in each of at least one selected light emission section by cooperation of (i) a discharge generated between each of the data electrodes and at least one of the sustain electrodes that is selected based on the selection of the at least one light emission section, and (ii) a sustain discharge (i.e., a sustained gas discharge) generated between mutually opposed surfaces of each adjacent pair of the sustain electrodes. Examples of such a plasma display panel are disclosed in JP-2004-235042 and JP-2004-247211A (publications of unexamined Japanese Patent Applications laid open in 2004).

The above-described plasma display panel is categorized as a three-electrode AC plasma display panel that is arranged to display an image, for example, by directly utilizing a light such as neon orange which accompanies plasma generated by the gas discharge, or utilizing a light emitted by phosphor which is disposed in each light emission section (i.e., pixel or cell) and is excited by the plasma. Such a principle of displaying an image permits the display panel to have a flat plate shape that is easily adapted to be large in its screen size and small in its thickness and weight, and enables the display panel to have a high response speed and a wide angle of visibility as a CRT. The plasma display panel is, therefore, considered as a favorable substitute for a CRT.

The above-identified Japanese publications (JP-2004-235042 and JP-2004-247211A) disclose an arrangement in which a lattice-shaped sheet member is provided between the front plate and the plurality of ribs, wherein the lattice-shaped sheet member includes: (i) a lattice-shaped dielectric layer having first portions each elongated in the above-described first direction and second portions each elongated in the second portion; (ii) a plurality of conductive bodies each disposed on a corresponding one of the second portions of the lattice-shaped dielectric layer and elongated in the second direction; and (iii) a dielectric film covering the dielectric layer and the conductive bodies, and wherein the sustain electrodes are provided by the conductive bodies, while the dielectric layer is provided by the dielectric film. This arrangement eliminates necessity of a heat treatment for forming the sustain electrodes on an inside surface of the front plate, thereby making it possible to avoid distortion of each component of the display panel, which could be caused by the heat treatment. Further, since the sustain discharge is generated between the mutually opposed surfaces of each adjacent pair of the sustain electrodes, it is possible to reduce variation in discharge voltage between the light emission sections, thereby resulting in an advantageous increase in its operation margin.

In the three-electrode AC plasma display panel, at least one of the light emission sections is selected by formation of wall charge therein that is made by generating a writing discharge between each of the data electrodes and one of a corresponding one adjacent pair of the sustain electrodes. The formed wall charge is superimposed on a sustain voltage applied between the corresponding one adjacent pair of the sustain electrodes, whereby the voltage in the selected light emission section is made to exceed a discharge initiating voltage. The sustain discharge in the selected light emission section is generated and sustained for a predetermined length of time.

The above-described wall charge has to be formed on either one of the mutually opposed surfaces of the adjacent pair of the sustain electrodes between which the sustain discharge is generated. However, a gap distance between each of the sustain electrodes (disposed above the ribs) and the data electrodes (disposed on the inside surface of the back plate) is minimized at a position right below the sustain electrode in question, so that the wall charge is likely to be formed on a lower surface of the sustain electrode, i.e., on a surface of the dielectric layer located on a side of the back plate, thereby disabling reliable generation of the visible light in the selected light emission section.

### SUMMARY OF THE INVENTION

The present invention was made in the light of the background art discussed above. It is an object of the present invention to provide a plasma display panel of three-electrode AC-type in which a discharge is generated between mutually opposed surfaces of each adjacent pair of electrodes and which is capable of generating a visible light in each selected light emission section. This object may be achieved according to any one of first through fifth aspects of the invention which are described below.

The first aspect of this invention provides a plasma display panel including: (a) front and back plates disposed in parallel with each other and cooperating to define a gas-tight space therebetween; (b) a plurality of data electrodes each disposed on an inside surface of the back plate and elongated in a first direction; (c) a plurality of ribs each disposed between a corresponding adjacent pair of the data electrodes and elongated in the first direction; and (d) a plurality of sustain electrodes each covered with a dielectric layer, disposed between the front plate and the plurality of ribs, and elongated in a second direction intersecting the first direction, wherein the plasma display panel is operable to produce an image which can be seen through the front plate and which is formed of a visible light that is generated in each of at least one selected light emission section by cooperation of (i) a discharge generated between each of the data electrodes and at least one of the sustain electrodes that is selected based on the selection of the at least one light emission section, and (ii) a sustain discharge generated between mutually opposed surfaces of each adjacent pair of the sustain electrodes, and wherein each of the ribs has a height that is smaller than a certain value of an electrode gap distance which minimizes a discharge initiating voltage in Paschen curve representative of a relationship between the discharge initiating voltage and a product of the electrode gap distance and a pressure in the gas-tight space.

In the plasma display panel constructed according to the invention, the sustain electrodes are separated by the ribs from the data electrodes, and are spaced apart from the data electrodes by a distance that is smaller than the certain value of the electrode gap distance which minimizes the discharge initiating voltage. This arrangement provides a discharge distance minimizing the discharge initiating voltage, where the discharge is effected in a direction that is not perpendicular to surfaces of the data electrodes. Such a discharge distance minimizing the discharge initiating voltage can be established not only between each data electrode and a lower surface of the corresponding sustain electrode but also between each data electrode and a side surface of the corresponding sustain electrode (i.e, one of the mutually opposed surfaces between which the sustain discharge is generated). Thus, with application of the voltage between the sustain and data electrodes for generating the writing discharge therebetween, the writing discharge is generated at least between the data electrode and the side surface of the sustain electrode, whereby an amount of the wall charge on the side surface can be adjusted. That is, a suitable amount of the wall charge can be formed on one of the mutually opposed surfaces that is used for generation of the sustain discharge, whereby a visible light can be reliably generated in the selected light emission section, owing to the formation of the suitable amount of the wall charge. In an AC plasma display panel, where each electrode is covered with a dielectric layer or coating, the term “discharge distance” is commonly interpreted to mean a distance measured from a surface of the dielectric layer or coating, i.e., a distance measured in the gas-tight space. In the present specification, where each electrode is covered with a dielectric layer or coating, the term “surface of the electrode” used in description regarding the discharge distance is interpreted to mean the surface of the dielectric layer or coating, unless otherwise specified. It is further noted that the plasma display panel of the invention may include, in addition to the above-described plurality of ribs as a plurality of first ribs, a plurality of second ribs disposed between the front plate and the sustain electrodes, so that the sustain electrodes are located between the first ribs and the second ribs in a height direction of the first and second ribs, namely, in a direction in which the front and back plates are opposed to each other. It is still further noted that, where the data electrodes are covered by a dielectric coating from which the ribs extend, the above-described height of the ribs corresponds to a distance by which the ribs extend from the dielectric coating in a direction away from the back plate toward the front plate.

In a three-electrode AC plasma display panel having a surface discharge arrangement in which the sustain electrodes are disposed on the inside surface of the front plate, since the writing discharge as well as the sustain discharge is performed on the surfaces of the sustain electrodes, the gap distance between the data and sustain electrodes does not affect generation of the visible light in each selected light emission section. However, as in the plasma display panel of the present invention, where there is established an opposed discharge arrangement in which the sustain discharge is generated between the mutually opposed surfaces of each adjacent pair of the sustain electrodes, while the data electrodes are disposed on the inside surface of the back plate, the gap distance between the opposed surfaces (side surfaces) of the sustain electrodes and the data electrodes is always smaller than the gap distance between lower surfaces of the sustain electrodes and the data electrodes. Therefore, if the writing discharge is performed with such a discharge distance that causes the above-described product (of the electrode gap distance and the pressure) to be sufficiently large, as in the conventional surface discharge arrangement, it is difficult to assure a reliable generation of the visible light in each selected light emission section, since the wall charge is likely to be formed only on the lower surface of the sustain electrode.

According to the second aspect of the invention, in the plasma display panel defined in the first aspect of the invention, there is provided a lattice-shaped sheet member disposed between the front plate and the plurality of ribs, wherein the lattice-shaped sheet member includes: a lattice-shaped dielectric layer having first portions each elongated in the first direction and second portions each elongated in the second portion; a plurality of conductive bodies each disposed on a corresponding one of the second portions of the lattice-shaped dielectric layer and elongated in the second direction; and a dielectric film covering the dielectric layer and the conductive bodies, and wherein the sustain electrodes are provided by the conductive bodies, while the dielectric layer is provided by the dielectric film.

This arrangement makes it possible to easily establish the sustain electrodes in the opposed discharge arrangement of the three-electrode AC plasma display panel, by simply disposing the lattice-shaped sheet member between the front plate and the plurality of ribs, namely, by disposing the sheet member on top ends of the respective ribs. In the plasma display panel of the present invention, although the plurality of sustain electrodes may be formed by a printing method or other suitable method, the simplest method of formation of the sustain electrodes is disposing the sheet member on the top ends of the respective ribs as in the above-described arrangement.

A lower limit of the height of the ribs is not particularly limited, as long as the height of the ribs can establish a discharge direction which is not perpendicular to the surfaces of the data electrodes and which causes the discharge initiating voltage required for initiation of the discharge between the data electrode and the side surface of the sustain electrode, to be sufficiently lower than the discharge initiating voltage required for initiation of the discharge between the data electrode and the lower surface of the sustain electrode.

According to the third aspect of the invention, in the plasma display panel defined in the first or second aspect of the invention, there are provided a plurality of phosphor layers which are disposed in the gas-tight space and which are to be excited to generate the visible light, wherein the phosphor layers are constituted by phosphor bodies of one or at least two kinds. This arrangement makes it possible to display various images, by preparing the phosphor layers suitable for desired images that are to be displayed.

According to the fourth aspect of the invention, in the plasma display panel defined in the third aspect of the invention, the phosphor layers are disposed on the inside surfaces of the front and back plates and side surfaces of the ribs. In this arrangement in which the phosphor layer are disposed on the side surfaces of the ribs as well as on the inside surfaces of the front and back plates, a brightness of the generated visible light is reduced with reduction in the height of the ribs, since the reduction in the rib height leads to reduction in an area of the side surfaces in which the phosphor layers are to be disposed. In this arrangement, therefore, it is preferable that the height of the ribs is maximized within such a range that assures a reliable generation of the visible light in each selected light emission section, which generation is made by using the side surfaces of the sustain electrodes for generating the sustain discharge.

According to the fifth aspect of the invention, in the plasma display panel defined in any one of the first through fourth aspects of the invention, the height of each of the ribs is not smaller than 5 (μm). It is preferable that the height of the ribs is not smaller than a value which assures an allowable minimum discharge distance from the sustain electrodes to the surfaces of the data electrodes, which distance is dependent upon a gap distance between the discharge surfaces (side surfaces) of each adjacent pair of the sustain electrodes and a height of the sustain electrodes as measured in a direction away from the back plate to the front plate.

### BRIEF DESCRIPTION OF THE DRAWINGS

The above and other objects, features, advantages and technical and industrial significance of this invention will be better understood by reading the following detailed description of presently preferred embodiment of the invention, when considered in connection with the accompanying drawings, in which:

FIG. 1 is a perspective view showing a main portion of a PDP (plasma display panel) constructed according to an embodiment of the invention, with its front plate being partially cut away;

FIG. 2 is a perspective view of a lattice-shaped sheet member provided in the PDP of FIG. 1;

FIG. 3 is a cross sectional view taken along one of ribs provided in the PDP of FIG. 1, for explaining discharges performed therein;

FIG. 4 is a graph showing a relationship between a discharge initiating voltage and a pd value (product of a gas pressure and an electrode gap distance) in the PDP of FIG. 1;

FIG. 5 is a view showing directions in which reading discharges are performed in the PDP of FIG. 1;

FIG. 6 is a view showing a black and white check pattern as an example displayed in the PDP of FIG. 1;

FIG. 7 is a cross sectional view corresponding to that of FIG. 3, showing a construction of a conventional PDP; and

FIG. 8 is a view showing a black and white check pattern as an example displayed in the PDP of FIG. 7.

### DETAILED DESCRIPTION OF THE PREFERRED EMBODIMENT

There will be described in detail an embodiment of the present invention, with reference to the drawings. It is noted that elements which will be described are not necessarily accurately illustrated in the drawings, particularly in their configurations and relative dimensions.

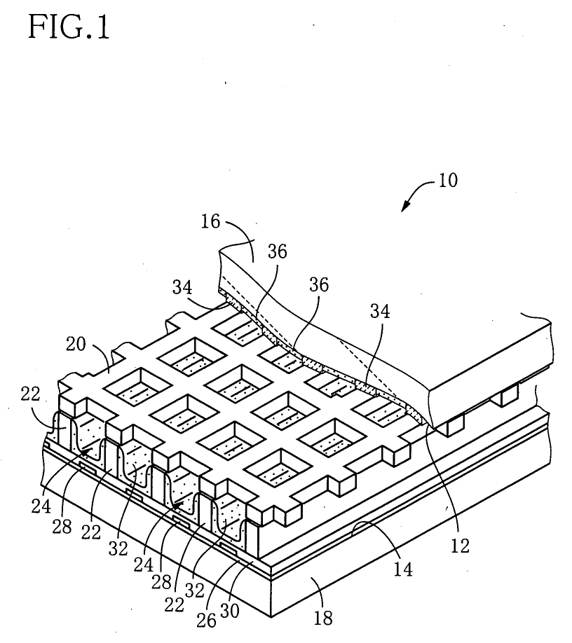

FIG. 1 shows an AC type color plasma display panel 10 (hereinafter simply referred to as “PDP”) constructed according to the embodiment of the invention. This PDP 10, having a screen size (diagonal viewable image size) of about 20 inches (i.e., 400×300 mm), is used as an element of a so-called tile-type display device that provides a giant screen. That is, a plurality of the PDPs 10 are arranged in horizontal and vertical directions while being held in close contact with one another, so as to cooperate with one another to constitute the tile-type display device.

The PDP 10 includes front and back plates 16, 18 that are disposed in parallel with each other and spaced apart from each other by a small distance, such that substantially flat surfaces 12, 14 of the respective plates 16, 18 are opposed to each other. The front and back plates 16, 18 are fixed relative to each other, with a lattice-shaped sheet member 20 (i.e., thick film sheet electrode) being interposed therebetween. The plates 16, 18 are gas-tightly sealed at their peripheries, for forming a gas-tight space therebetween. Each of the plates 16, 18 is provided by a translucent plate having a size of about 450×350 (mm) and a uniform thickness of from about 1.1 (mm) to about 3 (mm). The translucent plate is formed of, for example, soda-lime glass having a softening point of about 700 (C). The gas-tight space is filled with a discharge gas such as Ne—Xe (15%) gas at a pressure of about 6×10⁴ (Pa) [=450 (Torr)].

On the back plate 18, there are disposed a plurality of partition walls or barrier ribs 22 which are elongated or extend in a first direction in parallel with one another, such that centerlines of the ribs 22 are equally spaced at an interval of from about 0.2 (mm) to about 3 (mm), for example, of about 1.0 (mm). Thus, the gas-tight space defined between the front and back plates 16, 18 is divided into a plurality of discharge spaces 24. Each of the ribs 22 is formed of a thick film that contains, as its main component, a glass having a low softening point, such as PbO-B₂O₃—SiO₂—Al₂O₃—ZnO—TiO₂ glasses or a combination of two or more of these glasses, and has a width of from about 60 (μm) to about 1.0 (mm), for example, of about 200 (μm), and a height of from about 5 (μm) to about 300 (μm), for example, of about 20 (μm). An inorganic filler such as alumina and/or other inorganic pigments are added, as needed, to the ribs 22, so as to adjust a degree of compactness, a degree of strength, and/or a shape keeping ability of the ribs 22. The lattice-shaped sheet member 20 includes portions elongated or extending in the above-described first direction. The sheet member 20 is positioned relative to the ribs 22 such that those portions are superposed on top ends of the respective ribs 22.

On the back plate 18, there is provided an undercoat 26 which covers a substantially entire surface of the inner surface 14 of the back plate 18 and is formed of a low-alkali glass or a non-alkali glass. On the undercoat 26, there are provided a plurality of writing or data electrodes 28 which extend in a longitudinal direction of the ribs 22 and each of which is formed of a silver thick film or the like. The data electrodes 28 are covered by an overcoat 30 which is formed of a mixture of a low softening point glass and an inorganic filler such as a white-color titanium oxide. The ribs 22 are formed to extend upwardly from the overcoat 30. In the present embodiment, the undercoat 26 and overcoat 30 cooperate with each other to constitute a dielectric coating that covers the data electrodes 28.

On the surface of the overcoat 30 and on side surfaces of the respective partition walls 22, there are provided a plurality of phosphor layers 32 which are distinguished from each other so as to correspond to the plurality of discharge spaces 24, respectively. Each of the phosphor layers 32 has a thickness of from about 10 (μm) to about 20 (μm), for example, of about 15 (μm), depending upon its fluorescent color. The phosphor layers 32 are grouped into three groups of layers 32 that emit, by ultraviolet-light excitation, three fluorescent colors, e.g., red color (R), green color (G), and blue color (B), respectively. The phosphor layers 32 are arranged such that each one of the layers 32, and two layers 32 located on either side of the each layer 32 emit the three different fluorescent colors, respectively, in the corresponding three discharge spaces 24, respectively. The undercoat 26 and overcoat 30 are provided for the purpose of preventing the reaction between the silver-thick-film-based data electrodes 28 and the back plate 18, and preventing the contamination of the phosphor layers 32.

Meanwhile, on the inner surface 12 of the front plate 16, a plurality of partition wall or barrier ribs 34 are provided in respective positions opposed to the above-described barrier ribs 22, so as to be arranged in a stripe pattern. For serving also as a black stripe, each of the ribs 34 is formed of, for example, a material constituted by the material forming each rib 22 and black pigment powder (e.g., black metal oxide powder) dispersed therein, and has a thickness (height) of from about 5 (μm) to about 300 (μm), for example, of about 15 (μm). In addition to the barrier ribs 34, a plurality of phosphor layers 36 are provided to be arranged in a stripe pattern. Each of the phosphor layers 36 is located between a corresponding pair of the ribs 34 that are adjacent to each other, and has a thickness of from about 3 (μm) to about 50 (μm), for example, of about 5 (μm). The phosphor layers 36 are arranged such that each of the layers 36 emits, in a corresponding one of the discharge spaces 24, the same fluorescent color as the fluorescent color emitted in the one discharge space 24 by a corresponding one of the phosphor layers 32 provided on the back plate 18. The ribs 34 have a height larger than the thickness of the phosphor layers 36, for the purpose of preventing the sheet member 20 from being brought into contact with the phosphor layers 36.

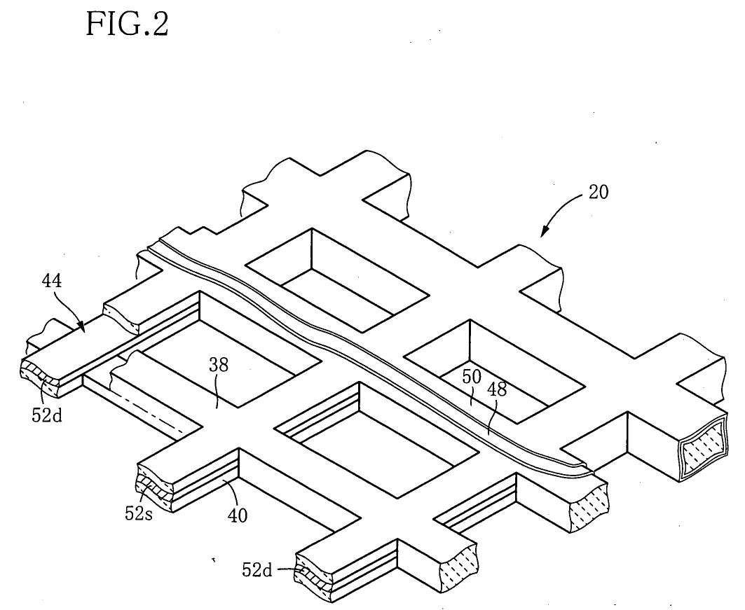

FIG. 2 is a perspective view showing the lattice-shaped sheet member 20, with a part thereof being cut away. The sheet member 20 has, in its entirety, a thickness of from about 50 (μm) to about 500 (μm), for example, of about 170 (μm), and includes an upper dielectric layer 38, a lower dielectric layer 40, a conductive layer 44, a dielectric film 48 and a protective film 50. The conductive layer 44 is interposed between the upper and lower dielectric layers 38, 40, and cooperates with the dielectric layers 38, 40 to constitute a layered structure that is entirely covered with the dielectric film 48. The protective film 50 covers the dielectric film 48, and provides an outermost portion of the sheet member 20.

The upper and lower dielectric layers 38, 40 have lattice shapes that are substantially identical with each other in the plan view. Each of the dielectric layers 38, 40 has a thickness of from about 10 (μm) to about 200 (μm), for example, of about 50 (lim), and is formed of a dielectric thick-film material that contains a low softening point glass such as PbO-B₂O₃—SiO₂—Al₂O₃—ZnO—TiO₂ glasses or a combination of two or more of these glasses (e.g., Al₂O₃—SiO₂—PbO glasses) and a ceramic filler such as alumina. In the present embodiment, each of the upper and lower dielectric layers 38, 40 corresponds to a lattice-shaped dielectric layer. Each of the dielectric layers 38, 40 has first portions each elongated or extending in the above-described first direction (in which the barrier ribs 22 are elongated or extend) and second portions each elongated or extending in a second direction that is perpendicular to the first direction. Each of the first portions has a width substantially equal to the width of the ribs 22 or somewhat larger than the width of the ribs 22 in consideration of alignment margin, for example, a width of from about 70 (μm) to about 1.1 (mm), for example, of about 300 (μm); The centerlines of the first portions are equally spaced apart at an interval of about 1.0 (mm), namely, at the same interval as the ribs 22. Each of the second portions has a width sufficiently smaller than the width of each first portion, for example, a width of from about 60 (μm) to about 1.0 (mm), for example, of about 150 (μm). The centerlines of the second portions are equally spaced apart at an interval of from about 200 (μm) to about 1.0 (mm), for example, of about 500 (μm). With these dimensions of the first and second portions of each of the dielectric layers 38, 40, each of openings of the lattice has a size of, for example, about 700×350 (μm).

The conductive layer 44 is provided by a relatively porous conductive thick layer having a porosity of, for example, about 30 (%) and containing a conductive component in the form of, for example, aluminum (Al). The thickness of the conductive layer 44 is from about 10 (μm) to about 100 (μm), for example, of about 70 (m). The conductive layer 44 is constituted by a plurality of conductive bodies in the form of stripe-like conductive thick films 52 that are elongated or extend along the respective second portions of each of the upper and lower dielectric layers 38, 40, namely, elongated or extending in the second direction that is perpendicular to the first direction in which the ribs 22 and the data electrodes 28 are elongated or extend. Each of the stripe-like conductive thick films 52 has a width which is substantially equal to the width of the second portions of each of the dielectric layers 38, 40, or which is somewhat larger that the width of the second portions of each of the dielectric layers 38, 40 so as to slightly project in widthwise opposite directions from the corresponding second portion of each of the dielectric layers 38, 40. The centerlines of the conductive thick films 52 are equally spaced apart at an interval of about 500 (μm), namely, at the same interval as the second portions of each of the dielectric layers 38, 40. It is noted that the conductive thick films 52 consists of common ones (52d) connected to a common wire, and individual ones (52s) connected to respective individual wires. The common ones (52d) and the individual ones (52s) are alternately arranged in the longitudinal direction of the ribs 22.

The dielectric film 48 is provided by a thick film containing a low softening point glass such as PbO-B₂O₃—SiO₂—Al₂O₃—ZnO—TiO₂ glasses or a combination of two or more of these glasses. The dielectric film 48 has a first thickness which is measured on the side surfaces of the dielectric layers 38, 40 and conductive layer 44 (i.e., inner wall surfaces of the lattice), and a second thickness which is measured on the upper and lower surfaces of the respective dielectric layers 38, 40 and which is sufficiently smaller than the first thickness. The first thickness of the dielectric film 48 is from about 10 (μm) to about 100 (μm), for example, of about 50 (μm). The dielectric film 48 is provided mainly for the purpose of storing electric charges on its surface and thereby causing an alternating-current discharge, as described below. In addition, the dielectric film 48 avoids exposure of the conductive layer 44 provided by the thick layer, and accordingly serves to restrain generation of outgas from the conductive layer 44 and change of atmosphere in the discharge space 24.

The protective film 50 has a thickness of, for example, about 0.5 (μm), and is provided by a thin or thick film which contains MgO or the like as its main component. The protective film 50 is provided for the purpose of preventing discharge-gas ion from causing sputtering of the dielectric film 48. However, since the protective film 50 is formed of a dielectric material having a high degree of secondary electron emission factor, the protective film 50 practically functions as discharge electrodes.

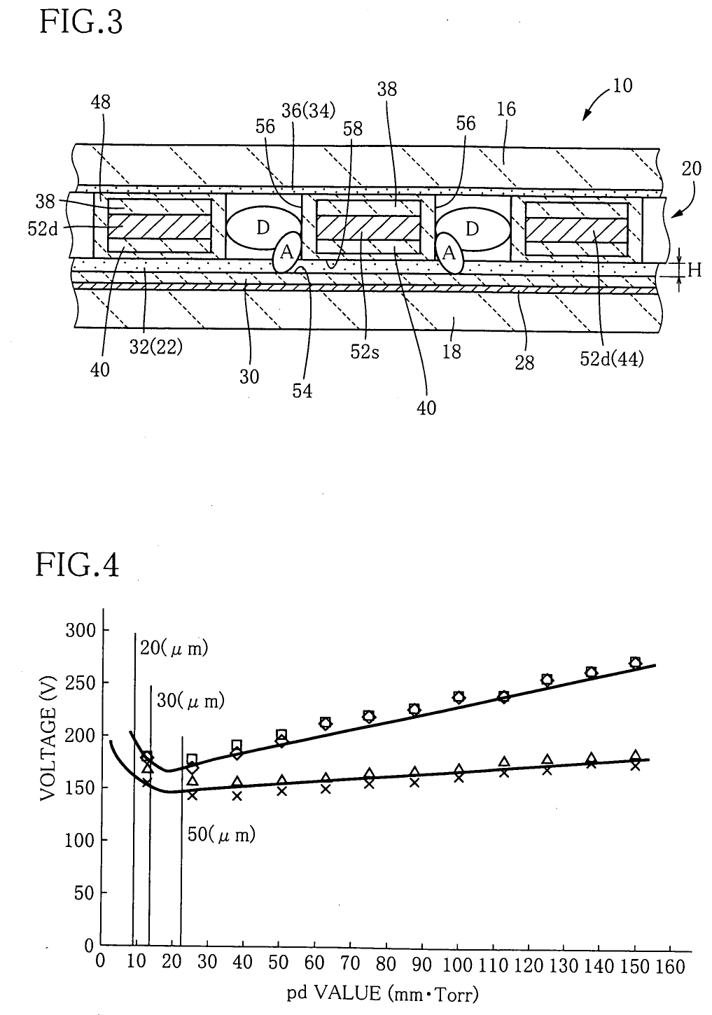

FIG. 3 is a view of a cross section of the PDP 10, which is parallel with the longitudinal direction of the ribs 22 and which is perpendicular to the longitudinal direction of the stripe-like conductive thick films 52. This cross sectional view of FIG. 3 is for explaining discharges performed in the PDP 10 having an electrode arrangement as described above. For activating the PDP 10, firstly, pulses having respective different polarities are concurrently applied between the conductive thick films 52s, 52d, so as to form wall charges in all the light emission sections. Next, an alternating current pulse is applied to the individual conductive thick films 52s so as to scan sequentially the same 52s, and concurrently an alternating current pulse is applied to predetermined ones of the data electrodes 28 (i.e., the data electrodes 28 corresponding to the light emission sections other than those selected to emit the visible light), in. synchronization with the timing of the scanning of the conductive thick films 52s. Consequently, as indicated by ellipses A in FIG. 3, the writing discharges are generated therebetween, whereby amounts of the wall charges on the protective film 50 are adjusted. It is noted that the PDP 10 may be activated also in another method in which the scanning is effected without the formation of the wall charges in all the light emission sections. In that case, a predetermined amount of the wall charge is accumulated in each light emission section selected to emit the light, by the writing discharges.

As is apparent from the above description regarding the activation of the PDP 10, in the present embodiment, the conductive thick films 52s serve as scanning electrodes used for display discharges and writing discharges, while the conductive thick films 52d serve as display electrodes used only for display discharges. Further, the conductive thick films 52s, 52d correspond to sustain electrodes.

In the activation of the PDP 10, the writing discharges are generated between overcoat surfaces 54 (i.e., surfaces of the data electrodes) and opposed discharge surfaces 56 (i.e., surfaces of the protective film 50 which cover the side surfaces of the scanning electrodes 52s and which are opposed to the display electrodes 52d), so that the wall charges are formed on the opposed discharge surfaces 56. The reason for which the generation of the discharges takes place between the overcoat and discharge surfaces 54, 56 is as follows:

FIG. 4 is a graph showing a result of a test that was conducted for measuring a relationship between a discharge initiating voltage and a product of an electrode gap distance d and a pressure p (i.e., a charged pressure of the discharge gas) within the discharge space 24 provided by the gas-tight space defined between the front and back plates 16, 18. In the graph of FIG. 4, “⋄” indicates a voltage which caused one of the cells to initiate to emit the light while the voltage was being gradually increased from a state in which non of the cells emitted the light, “□” indicates a voltage which caused all the cells to emit the lights, “Δ” indicates a voltage which caused one of the cells to terminate the light emission while the voltage was being gradually reduced from a state in which all the cells emitted the lights, and “×” indicates a voltage which caused all the cells not to emit the light. As shown in the graph of FIG. 4, the relationship between the above-described product (hereinafter referred to as “pd product”) and the discharge initiating voltage is represented by a generally V-shaped figure, which is known as Paschen's law. As indicated by the V-shaped figure, the discharge initiating voltage is reduced with increase in the electrode gap distance in a range in which a current value of the pd product is smaller than a value (a little smaller than 20 (mm-Torr) in the graph) of the pd product that minimizes the discharge initiating voltage, while the discharge initiating voltage is increased with increase in the electrode gap distance in a range in which a current value of the pd product is larger than the value of the pd product that minimizes the discharge initiating voltage.

In the present embodiment in which the gas pressure p is set at about 450 (torr), the pd product is about 22.5 (mm-Torr) when the electrode gap distance d is 50 (μm), the pd product is about 13.5 (mm-Torr) when the electrode gap distance d is 30 (μm), the pd product is about 9 (mm-Torr) when the electrode gap distance d is 20 (μm). The graph of FIG. 4 indicates that the discharge initiating voltage is substantially minimized when the electrode gap distance d is about 50 (μm), and that the discharge initiating voltage is higher when the distance d is 30 (μm) and 20 (μm) smaller than 50 (μm). As described above, since the height H of the ribs 22 is about 20 (μm), the distance between the surface 54 of the data electrode 28 and a protective film surface 58 (i.e., lower surface of the scanning electrode) located on a lower side of the scanning electrode 52s is about 20 (μm). Therefore, at least 200 (V) is required as discharge initiating voltage Vf for initiating the discharge therebetween from a state in which there is no electric potential in the cell, and at least 160 (V) is required as discharge sustaining voltage Vs for sustaining the discharge after its initiation. That is, in the present embodiment, the height H of the ribs 22 is set at a value small than the value of the electrode gap distance d of the pd product which minimizes the discharge initiating voltage in Paschen curve.

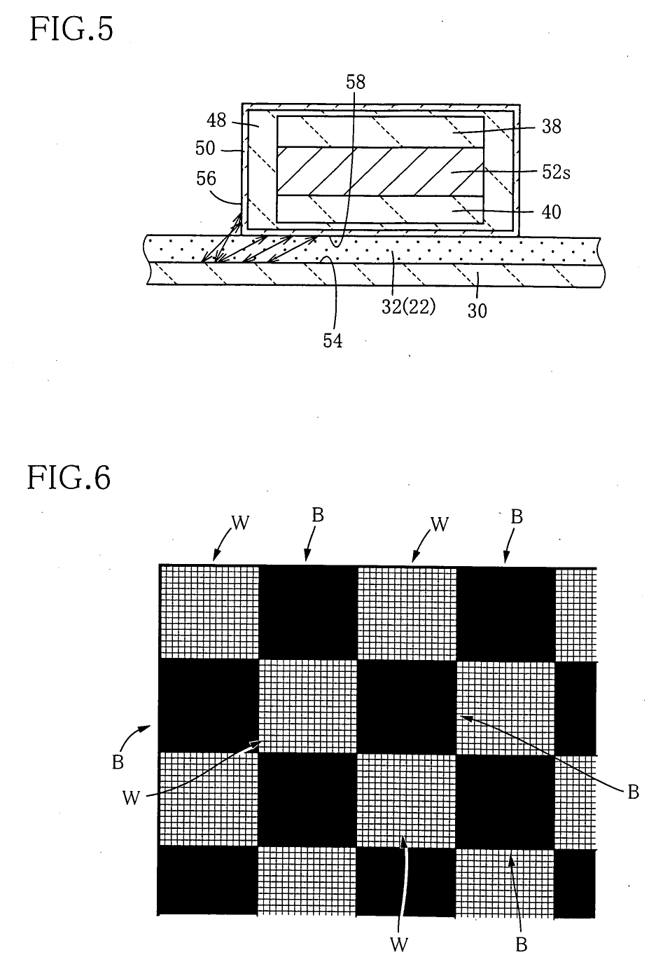

However, as indicated by arrows in FIG. 5, where the discharge direction is adapted to be not orthogonal or perpendicular to the data electrode surface 54, the electrode gap distance d can be taken to be increased to, for example, about 50 (μm), which substantially minimizes the required voltage in the graph of FIG. 4. Since such an electrode gap distance d can be established also between the data electrode surface 54 and the opposed discharge surface 56 as shown in FIG. 5, the writing discharge is generated between the surfaces 54, 56 in the direction not perpendicular to the data electrode surface 54 as indicated by the ellipse A in FIG. 3. Meanwhile, actually, the discharge between the data electrode surface 54 and the scanning electrode lower surface 58 is difficult to be caused, since the distance between the surfaces 54, 58 is extremely small. Therefore, in the present embodiment, the writing discharge is caused practically only between the data electrode surface 54 and the opposed discharge surface 56.

After scanning all the scanning electrodes 52s as described above, an alternating current pulse is applied to all the scanning and display electrodes 52s, 52d, the voltage is made to exceed the discharge initiating voltage in the light emission section in which the charge has been accumulated, since the voltage of the accumulated charge is superimposed on the applied voltage. Thus, in that light emission section, the discharge is generated between the mutually opposed discharge surfaces 56, 56 as indicated by ellipse D in FIG. 3, and the discharge is sustained by wall charge newly generated on the protective film 50 for a predetermined length of time. That is, since the opposed discharge surfaces 56 are utilized for the generation of the writing discharge, the wall charge is accumulated on the surface 56, so that the accumulated charge is advantageously utilized for the display discharge. Thus, the phosphor layers 32, 36 in the light emission section selected by ultraviolet light generated by the gas discharge are excited to emit the light, and the emitted light is injected through the front plate 16 whereby an image is displayed. Then, in each one cycle of the scanning of the scanning electrodes 52s, the data electrode 28 to which the alternating current pulse is applied is changed, whereby the desired images are successively displayed.

The sustain discharge is generated between the scanning and display electrodes 52s, 52d. However, since the discharge space 24 continuously extend in the longitudinal direction of the ribs 22, the ultraviolet light generated by the discharge expands outside the stripe-like conductive thick films 52 in that direction. Thus, not only the phosphor layers 32, 36 located inside the conductive thick films 52 but also those located outside the conductive thick films 52 are caused to emit the light, as long as the ultraviolet light reaches them. That is, a light emission unit (i.e., cell or light emission section) is defined by each adjacent pair of the ribs 22 in the above-described second direction that is perpendicular to the ribs 22, and is defined practically by a range of reach of the ultraviolet light in the above-described first direction that corresponds to the longitudinal direction of the ribs 22.

In the present embodiment, a cell pitch defining each light emission section in the above-described first direction (i.e., in the longitudinal direction of the ribs 22) is from about 100 (μm) to about 3.0 (mm), for example, of about 3.0 (mm), which is about six times as large as the interval between the centerlines of the lattice of the sheet member 20. That is, in the present embodiment, six openings of the lattice of the sheet member 20 are located in each one cell, so that the sustain discharge is performed between each of three pairs of the mutually opposed discharge surfaces 56 opening in the six openings. Since the centerlines of the ribs 22 are spaced apart at the interval of about 1.0 (mm) as described above, a pitch of pixels (each of which is constituted by the three colors such as red color (R), green color (G), and blue color (B)) is 3.0 (mm) as measured in both of the above-described first and second directions, and a size of each pixel is about 3.0×3.0 (mm).

FIG. 6 is a view showing a part of a display surface (i.e., surface of the front plate 16) caused to display a check pattern as a test pattern, with activation of the PDP 10. In the present embodiment in which the writing discharges are performed by utilizing the opposed discharge surfaces 56 as described above, the visible light can be reliably generated in each selected light emission section. Therefore, as shown in FIG. 6, the light emission sections located in each region W (that is to emit the lights) all emit the lights to provide a rectangular white image, meanwhile the light emission section located in each section B (that is not to emit the lights) do not emit the lights at all to provide a rectangular black image, as shown in FIG. 6. It is noted that thin lines described in a lattice within each white region W correspond to boundaries among the light emission sections, namely, the lattice of the sheet member 20. In each black region B, too, there are exist boundaries among the light emission sections, although they are not illustrated in the figure.

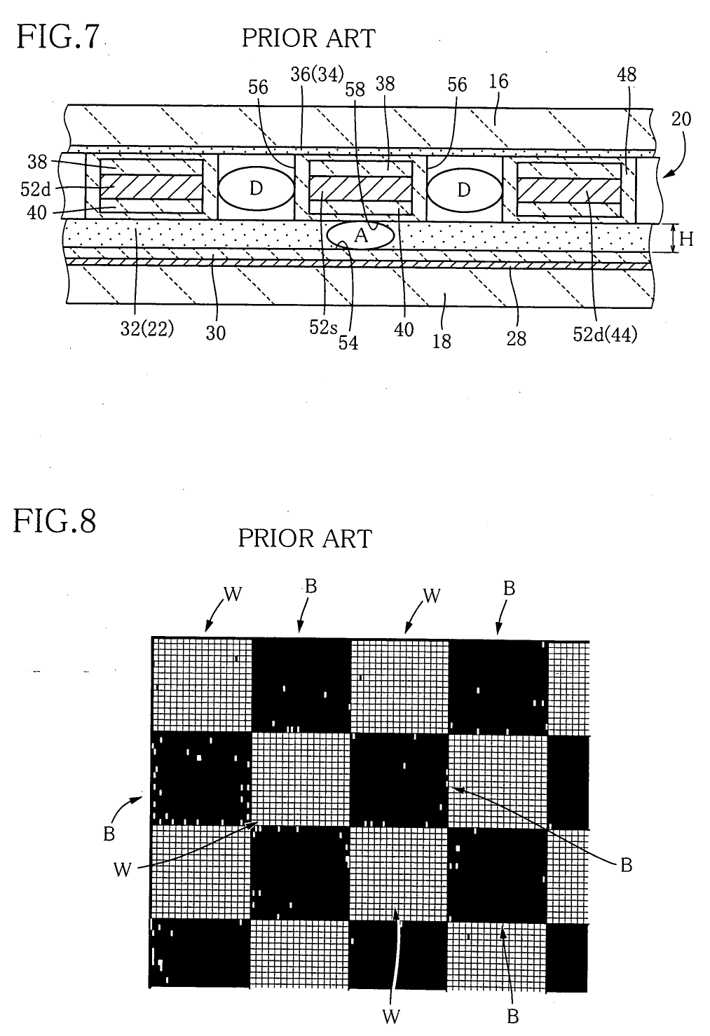

FIG. 7 is a cross sectional view corresponding to that of FIG. 3, showing a case where the ribs 22 are arranged to have a height H of about 50 (μm), which is larger than in the above-described embodiment. FIG. 8 is a view showing a check pattern displayed in such a case. In the construction of the above-described embodiment, the discharge initiating voltage is minimized when the electrode gap distance d is about 50 (μm), as shown in FIG. 4. Thus, when the height H of the ribs 22 is 50 (μm), since the distance between the data electrode surface 54 and the scanning electrode lower surface 58 is 50 (μm) that is sufficiently large, the writing discharge is generated between these surfaces 54, 58 in the above-descried method of activation of the PDP. Meanwhile, since the distance between the data electrode surface 54 and the opposed discharge surface 56 is larger than 50 (μm), the discharge initiating voltage required between these surfaces 54, 56 is made larger than that required between the data electrode surface 54 and the scanning electrode lower surface 58, so that the discharge between the surfaces 54, 56 is not caused at all or caused very little.

As is understood from the above description, in the activation method in which the discharges are first generated in all the light emission sections and then unnecessary ones of the wall charges (i.e., the charges accumulated in the light emission sections that are not to emit the lights) are erased by the writing discharges, the erase of the unnecessary wall charges can not be reliably done. Besides, in the other activation method in which the wall charges are accumulated by the writing discharges in the light emission sections that are to emit the lights, the wall charges are accumulated substantially exclusively on the lower surfaces 58 of the scanning electrodes 52s while the amount of the wall charges accumulated on the opposed discharge surfaces 56 is extremely small or zeroed, so that the wall charges do not substantially contribute to reduce the discharge initiating voltage during the period of display performed by the discharge generated between the opposed discharge surfaces 56, thereby disabling reliable generation of the visible light in each selected light emission section. Consequently, as shown in FIG. 8, some of the light emission sections located in each region W (that is to provide a while image) do not emit the lights, as indicated by black parts in each region W, while some of the light emission sections located in each region B (that is to provide a black image) emit the lights, as indicated by white parts in each region B, thereby resulting in deterioration in the display quality. In FIG. 8, the light emission sections emitting the lights in each region B are all indicated by the white parts. However, since each pixel is constituted by the light emission sections of the respective three colors (e.g., red color (R), green color (G), and blue color (B)), the actual color of the emitted light is one of the three colors, or is dependent on combination of the light emission sections caused to the emit the lights.

As described above, in the above-described embodiment, the distance between the scanning electrodes 52s and the writing electrodes 28 separated by the ribs 22 is adapted to be smaller than the value of the electrode gap distance that minimizes the discharge initiating voltage. This arrangement provides a discharge distance minimizing the discharge initiating voltage, where the discharge is effected in a direction that is not perpendicular to the data electrode surfaces 54. Such a discharge distance minimizing the discharge initiating voltage can be established not only between the data electrode surfaces 54 and the lower surfaces 58 of the scanning electrodes 52s but also between the data electrode surfaces 54 and the opposed discharge surfaces 56. Thus, with application of the voltage between the scanning and data electrodes 52s, 28 for generating the writing discharge therebetween, the writing discharge is generated between the data electrode 28 and the opposed discharge surface 56, whereby an amount of the wall charge on the opposed discharge surface 56 can be adjusted. That is, a suitable amount of the wall charge can be formed on the opposed discharge surface 56 that is used for generation of the sustain discharge, whereby a visible light can be reliably generated in the selected light emission section, owing to the formation of the suitable amount of the wall charge.

Further, in the above-described embodiment, there is provided the lattice-shaped sheet member 20 including the upper and lower dielectric layers 38, 40 and the conductive layer 44 interposed between the dielectric layers 38, 40, and the scanning and display electrodes 52s, 52d are provided by the conductive layer 44. This arrangement advantageously makes it possible to establish the sustain electrodes, by simply disposing the sheet member 20 on the top ends of the ribs 22.

While the embodiment of the present invention has been described above for illustrative purpose only, it is to be understood that the present invention may be embodied with various changes and improvements, which may occur to those skilled in the art, without departing from the sprit of the invention.

What is claimed is:

1. A plasma display panel comprising:
front and back plates disposed in parallel with each other and cooperating to define a gas-tight space therebetween;
a plurality of data electrodes each disposed on an inside surface of said back plate and elongated in a first direction;
a plurality of ribs each disposed between a corresponding adjacent pair of said data electrodes and elongated in said first direction; and
a plurality of sustain electrodes each covered with a dielectric layer, disposed between said front plate and said plurality of ribs, and elongated in a second direction intersecting said first direction,
wherein said plasma display panel is operable to produce an image which can be seen through said front plate and which is formed of a visible light that is generated in each of at least one selected light emission section by cooperation of (i) a discharge generated between each of said data electrodes and at least one of said sustain electrodes, and (ii) a sustain discharge generated between mutually opposed surfaces of each adjacent pair of said sustain electrodes,
and wherein each of said ribs has a height that is smaller than a certain value of an electrode gap distance which minimizes a discharge initiating voltage in Paschen curve representative of a relationship between said discharge initiating voltage and a product of said electrode gap distance and a pressure in said gas-tight space.

2. The plasma display device according to claim 1, comprising a lattice-shaped sheet member disposed between said front plate and said plurality of ribs,
wherein said lattice-shaped sheet member includes:
a lattice-shaped dielectric layer having first portions each elongated in said first direction and second portions each elongated in said second portion;
a plurality of conductive bodies each disposed on a corresponding one of said second portions of said lattice-shaped dielectric layer and elongated in said second direction; and
a dielectric film covering said dielectric layer and said conductive bodies,
and wherein said sustain electrodes are provided by said conductive bodies, while said dielectric layer is provided by said dielectric film.

3. The plasma display device according to claim 1, comprising a plurality of phosphor layers which are disposed in said gas-tight space and which are to be excited to generate said visible light.

4. The plasma display device according to claim 3, wherein said phosphor layers are disposed on the inside surfaces of said front and back plates and side surfaces of said ribs.

5. The plasma display device according to claim 1, wherein said height of each of said ribs is not smaller than 5 (μm).

6. The plasma display device according to claim 1,
wherein said plurality of data electrodes are covered by a dielectric coating,
and wherein said plurality of ribs extend from said dielectric coating in a direction away from said back plate toward said front plate, by a distance corresponding to said height.
